(19) United States
(12) Patent Application Publication
(10) Pub. No.: US 2026/0279304 A1
(43) Pub. Date: Sep. 17, 2026

(54) Augmented Reality Head-Mounted Display Equipped with Electrochromic Module

(71) Applicant: KOREA INSTITUTE OF SCIENCE AND TECHNOLOGY, Seoul (KR)

(72) Inventors: Min Koo KANG, Seoul (KR); Dae-Yong CHO, Seoul (KR)

(73) Assignee: KOREA INSTITUTE OF SCIENCE AND TECHNOLOGY, Seoul (KR)

(21) Appl. No.: 19/048,379

(22) Filed: Feb. 7, 2025

(30) Foreign Application Priority Data
Jul. 31, 2024 (KR) 10-2024-0101912

(51) Int. Cl. G09G 3/38; G06T 7/73; G09G 3/00

(52) U.S. Cl. CPC G09G 3/38; G06T 7/73; G09G 3/001; G06T 2207/10024; G06T 2207/30201; G09G 2320/0626; G09G 2354/00; G09G 2360/144

(57) ABSTRACT

The augmented reality head-mounted display according to embodiments of the present disclosure may comprise a display for presenting virtual objects generated using a plurality of cameras mounted outdoors to a user located indoors in a first-person point of view (POV), an electrochromic module for adjusting an opacity of the display, a user state detector for detecting a current state of the user utilizing a visual mechanism of the user, an illuminance detector for detecting an illuminance level of the indoors and the outdoors, and a processor for adjusting a brightness of the display and an opacity of the electrochromic module in response to the user's current state detected by the user state detector and the illuminance level detected by the illuminance detector.

### CROSS-REFERENCE TO RELATED APPLICATION

This application claims priority to and the benefit of Korean Patent Application No. 10-2024-0101912 filed in the Korean Intellectual Property Office on Jul. 31, 2024.

### BACKGROUND OF THE INVENTION

### (a) Field of the Invention

The present disclosure relates to a head-mounted display that provides augmented reality, and more specifically, to a head-mounted display that provides a first-person point of view (POV) to a user of a 360° panoramic image generated using a plurality of cameras mounted externally to tank or an armored vehicle, in conjunction with the user's head pose.

### (b) Description of the Related Art

Augmented reality (AR), a branch of virtual reality (VR), is a technology that synthesizes virtual objects or information in the real world to make them appear as if they exist in the original environment.

That is, AR technology projects an image of the virtual object onto the real world the user is looking at and shows it to the user.

AR technology allows users to experience a direct sense of reality that they would have experienced in the objective physical world, and to have experiences that they would not otherwise have in the real world.

AR is distinguished from VR, which does not allow you to see your actual surroundings, and is intended to provide better realism and additional information through a mix of real and virtual objects.

AR technology is becoming more and more widely applied due to the rapid advancement of the technology and the recent proliferation of smartphones.

One such AR-providing device is a head-mounted display (hereinafter referred to as ‘HMD’) that is worn on the head like a pair of eyeglasses, wherein the AR-providing HMD is configured to be see-through.

These conventional AR HMDs have a problem in that it is difficult to provide clear image information of virtual objects in a bright outdoor environment with strong ultraviolet light intensity. In other words, conventional AR HMDs have a problem in that image information of virtual objects is not clearly provided to users depending on whether it is a bright outdoor environment with strong sunlight or an indoor environment with weak sunlight, and inconvenience in use occurs as a result.

To solve these problems, Korean Public Patent Publication No. 10-2020-0095985 proposes a head-worn display device using a photochromic lens and an illuminance sensor.

The above prior patent comprises a photochromic lens that allows a real world to be seen, and an illuminance sensor that detects external illuminance. In addition, the above prior patent provides the image information to the user of a virtual object to the user based on the illuminance detected by the photochromic lens that changes color in response to the amount of ultraviolet rays and the illuminance sensor that detects external illuminance.

However, the prior patent discloses a configuration that only senses the amount of light and UV radiation in the space where the user wearing the AR HMD is located.

Thus, when a user wearing an AR HMD needs to observe an outdoor environment through the AR HMD, for example, when a user located inside the tank or the armored vehicle wants to recognize the surroundings outside of the tank or the armored vehicle through the AR HMD, there is a problem in that it is difficult to provide the user with an accurate, reliable, and less tiring virtual object image.

Furthermore, in a system for providing a 360° panoramic image generated using a plurality of cameras installed outside a vehicle such as the tank and the armored vehicle, etc. to a user through the AR HMD device for providing the user with a first-person POV in conjunction with the user's head pose, there is a problem that it is inconvenient for the user to perform monitoring of an external situation while simultaneously performing a specific task (for example, indoor equipment operation) indoors as needed.

### SUMMARY OF THE INVENTION

The present disclosure is to solve at least one of the above-described problems.

Another technical object of the present disclosure is to provide an AR HMD equipped with electrochromic module and a control method thereof that enables a user located indoors to effectively monitor an outdoor environment. The AR HMD of the present disclosure comprises an electrochromic module.

Another technical object of the present disclosure is to provide the AR HMD equipped with electrochromic module and a control method thereof that can effectively manage the visibility of real world and virtual objects based on the user's state.

Another technical object of the present disclosure is to provide the AR HMD equipped with electrochromic module and a control method thereof that the brightness value of a display and the opacity value of the electrochromic module, set in a low-light environment, are automatically updated in response to changes in external illuminance.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

The augmented reality head-mounted display according to embodiments of the present disclosure may comprise a display for presenting virtual objects generated using a plurality of cameras mounted outdoors to a user located indoors in a first-person point of view (POV), an electrochromic module for adjusting an opacity of the display, a user state detector for detecting a current state of the user utilizing a visual mechanism of the user, an illuminance detector for detecting an illuminance level of the indoor and the outdoors, and a processor for adjusting a brightness of the display and an opacity of the electrochromic module in response to the user's current state detected by the user state detector and the illuminance level detected by the illuminance detector.

In an augmented reality head-mounted display of the present disclosure, the user state detector may include a front-facing camera that generates an RGB image and a depth image; and a binocular camera that generates a left-eyeball image and a right-eyeball image of the user.

And the processor may classify a current state of the user based on the results detected by the user state detector, and may classify the current state of the user as one of an idle state, an outdoor environment monitoring state, and an indoor equipment operation state.

When classifying the current state of the user, the processor may estimate a two-dimensional gaze point in the RGB image based on the RGB image of the front-facing camera and the pupil detection information of the binocular camera, detect a fixed gaze point from the estimated two-dimensional gaze point, and determine whether the fixed gaze point is formed. When the fixed gaze point is not formed, the processor may classify the current state of the user as the idle state, and when the fixed gaze point is formed, estimate a binocular convergence angle-based gaze distance utilizing a pupil line of sight information extracted from the binocular image and the estimated two-dimensional gaze point information, setting a depth value of a point corresponding to the estimated two-dimensional gaze point to the two-dimensional gaze point-based depth value in the depth image acquired from the front-facing camera, and when an absolute value difference between the estimated binocular convergence angle-based gaze distance and the two-dimensional gaze point-based depth value is equal to or greater than a threshold, the current state of the user may classified as the outdoor environment monitoring state. And when the absolute value difference between the estimated binocular convergence angle-based gaze distance and the two-dimensional gaze point-based depth value is less than the threshold, the processor may classify the user's current state as the indoor equipment operation state.

In an augmented reality head-mounted display according to embodiments of the present disclosure, the illuminance detector may include an illuminance sensor to detect indoor illuminance, and the processor may measure indoor illuminance using an image generated by the front-facing camera and a signal from the illuminance sensor, and may measure outdoor illuminance using an eyeball image generated by the binocular camera or an outdoor image generated by the plurality of cameras.

The processor may perform an initialization step of setting an initial control value of the display and an initial control value of the electrochromic module according to the classified current state of the user and recording indoor illuminance information and outdoor illuminance information at that time in the memory, and an adaptive correction step of automatically adjusting the brightness of the display and the opacity of the electrochromic module so that the indoor illuminance and outdoor illuminance recorded in the memory are maintained.

And in the initialization step, the processor may perform an initial value setting step of setting a display brightness initial control value and an electrochromic module opacity initial control value for each user by applying a user-customized adjustment values to the preset display brightness and electrochromic module opacity adjustment values according to the classified current state of the user, and an environmental information recording step of recording indoor illuminance and outdoor illuminance in the memory along with the classified current state of the user.

And in the adaptive correction step, the processor may perform a target illuminance information acquisition step of retrieving indoor illuminance information and outdoor illuminance information corresponding to a classified current state of the user from memory, an environmental illuminance information extraction step of measuring an indoor illuminance detected from the front-facing camera and the illuminance sensor and an outdoor illuminance detected from an image of the binocular camera or an image of the plurality of cameras, and a correction control step of comparing the target illuminance information and measured environmental illuminance information to calculate and apply a display brightness correction control value and an electrochromic module opacity correction control value.

And in the correction control step, the processor may calculate an electrochromic module opacity correction control value that minimizes the difference between the indoor illuminance set value and the indoor illuminance measured value, and may calculate a display brightness control value that minimizes the difference between the outdoor illuminance set value and the outdoor illuminance measured value under the calculated electrochromic module opacity condition, and may calculate the correction control value to reduce the brightness of the display and the opacity of the electrochromic module when the real world is closer than a certain distance by referring to a minimum distance value of the depth image.

According to an augmented reality head-mounted display disclosed herein, the brightness of the display and the opacity value of the electrochromic module set in a low-light environment can be automatically updated in response to changes in external illuminance.

Thus, a user located indoors can effectively monitor the outdoor environment, and the visibility of real world and virtual objects can be effectively managed based on the user's state.

Furthermore, in a local situational awareness system used in tanks, armored vehicles, and the like, a 360° panoramic image generated using a plurality of externally installed cameras can be provided to a user in a first-person point of view (POV) in conjunction with the user's head pose.

Furthermore, the augmented reality head-mounted display of the present disclosure can be combined with artificial intelligence to augment perception information such as target identification/tracking/alarming for a 360° battlefield environment.

Furthermore, the visibility of virtual objects of the external environment captured by external cameras and the indoor environment perceived through transmissive optics can be effectively managed.

In addition, the user can effectively perform monitoring of the external situation and, if necessary, effectively perform certain tasks indoors (for example, operating indoor equipment).

Effects that could be achieved with the present disclosure are not limited to those that have been described hereinabove merely by way of example, and other effects and advantages of the present disclosure will be more clearly understood from the following description by a person skilled in the art to which the present disclosure pertains.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 is a schematic diagram of a local situational awareness system having an augmented reality head-mounted display, in accordance with embodiments of the present disclosure.

FIG. 2 is a diagram illustrating a method of utilizing visual mechanisms to categorize a user's current state.

FIG. 3 is a diagram illustrating an initialization step of a method for adjusting display brightness and electrochromic module opacity.

FIG. 4 is a diagram specifically illustrating one example of the initialization step illustrated in FIG. 3.

FIG. 5 is a diagram illustrating an adaptive correction step of a method for adjusting display brightness and electrochromic module opacity.

FIG. 6 is a diagram specifically illustrating one example of the adaptive correction step illustrated in FIG. 5.

FIG. 7 is a diagram illustrating a view observed on the display based on the user's current state and indoor illuminance without applying adaptive correction.

FIG. 8 is a diagram illustrating a view observed on a display based on the user's current state and indoor illuminance with adaptive correction applied.

FIG. 9 is a diagram specifically illustrating another example of the initialization step illustrated in FIG. 3.

FIG. 10 is a diagram specifically illustrating another example of the adaptive correction step illustrated in FIG. 3.

### DETAILED DESCRIPTION OF THE EMBODIMENTS

Reference will now be made in detail to embodiments of the present disclosure, examples of which are illustrated in the accompanying drawings. Wherever possible, the same reference numbers will be used throughout the drawings to refer to the same or like parts.

In general, a suffix such as “assembly” and “unit” may be used to refer to elements or components. Use of such a suffix herein is merely intended to facilitate description of the present disclosure, and the suffix itself is not intended to give any special meaning or function.

It will be noted that a detailed description of known arts will be omitted if it is determined that the detailed description of the known arts can obscure embodiments of the present disclosure.

The accompanying drawings are used to help easily understand various technical features and it should be understood that embodiments presented herein are not limited by the accompanying drawings. As such, the present disclosure should be understood to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When any component is described as “being coupled to” or “being assembled with” other component, this should be understood to mean that another component may exist between them although any component may be directly coupled to or assembled with the other component.

On the other hand, when any component is described as “being directly coupled to” or “being assembled with” other component, this should be understood to mean that no component exists between them.

A singular expression can include a plural expression as long as it does not have an apparently different meaning in context.

In embodiments of the present disclosure, terms “include or comprise” or “have” should be understood to be intended to designate that illustrated features, numbers, steps, operations, components, parts or combinations thereof are present and not to preclude the existence of one or more other features, numbers, steps, operations, components, parts or combinations thereof, or the possibility of the addition thereof.

Reference will now be made in detail to embodiments of the present disclosure, examples of which are illustrated in the accompanying drawings. Wherever possible, the same reference numbers will be used throughout the drawings to refer to the same or like parts.

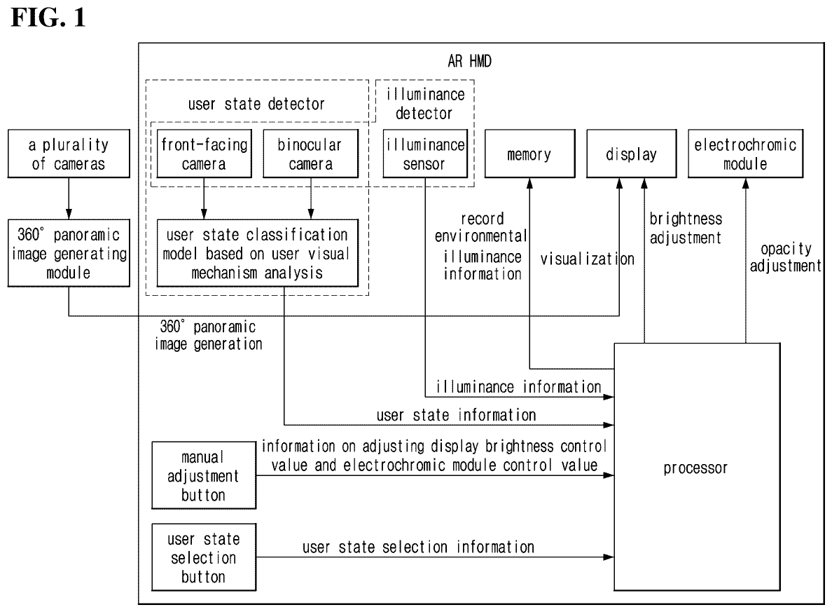

Referring now to FIGS. 1 through 8, an augmented reality head-mounted display according to one embodiment of the present disclosure will be described.

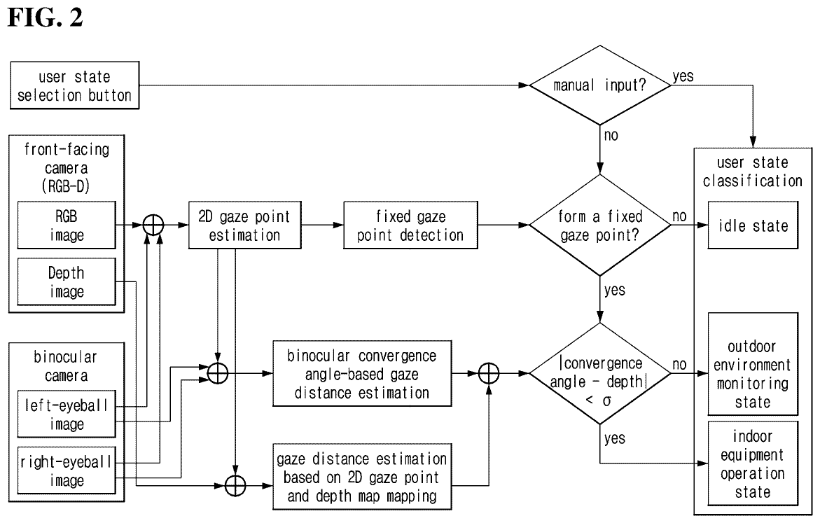

FIG. 1 is a schematic diagram of a local situational awareness system having an augmented reality head-mounted display, in accordance with embodiments of the present disclosure, and FIG. 2 is a diagram illustrating a method of utilizing visual mechanisms to categorize a user's current state.

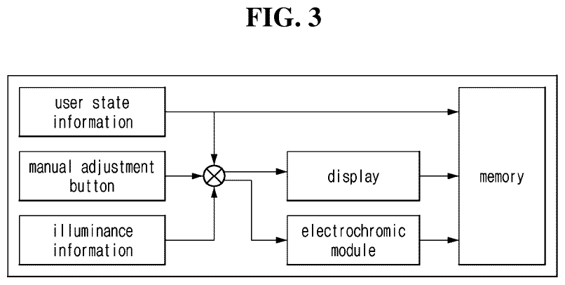

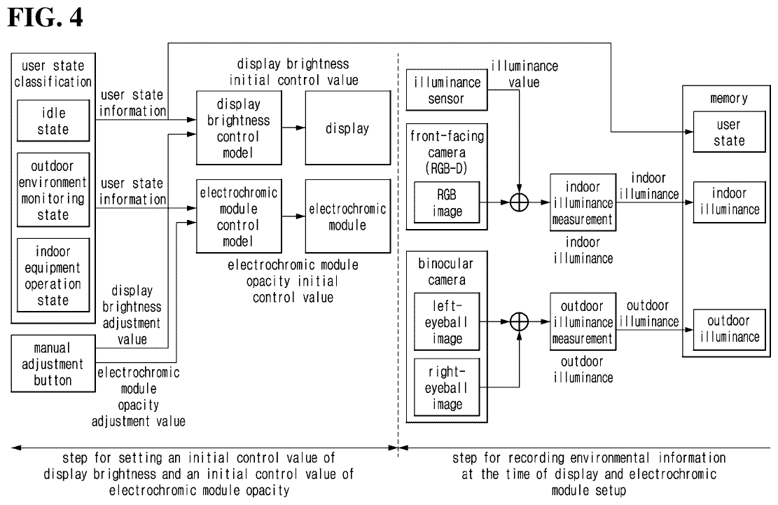

And FIG. 3 is a diagram illustrating an initialization step of a method for adjusting display brightness and electrochromic module opacity, and FIG. 4 is a diagram specifically illustrating one example of the initialization step illustrated in FIG. 3.

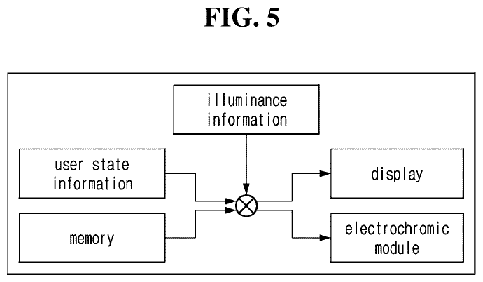

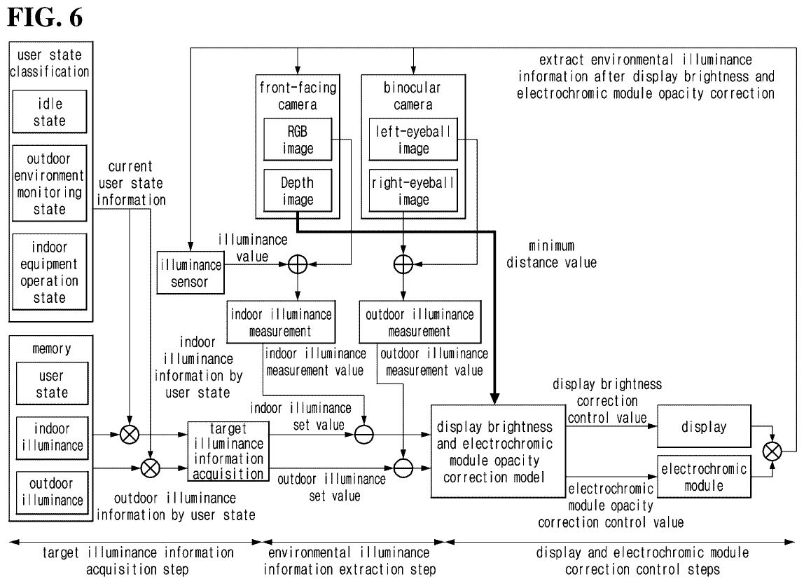

And FIG. 5 is a diagram illustrating an adaptive correction step of a method for adjusting display brightness and electrochromic module opacity, and FIG. 6 is a diagram specifically illustrating one example of the adaptive correction step illustrated in FIG. 5.

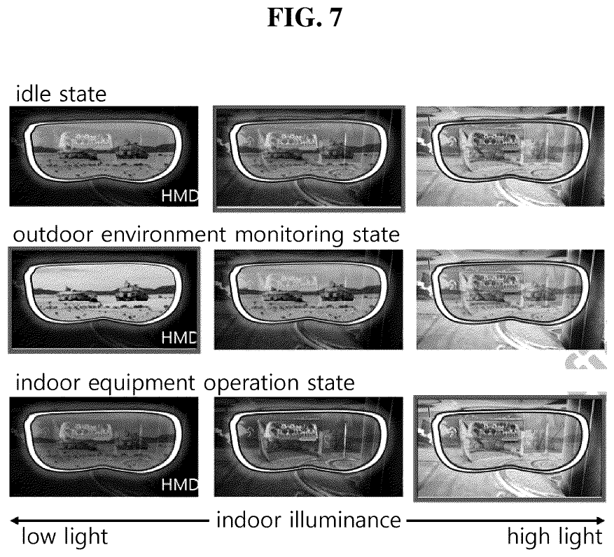

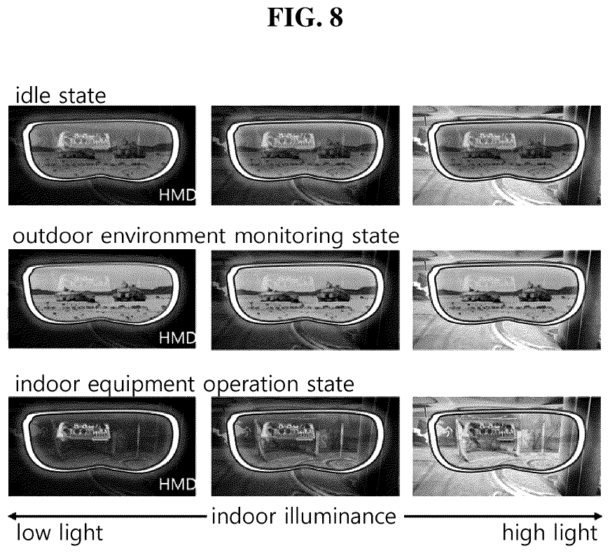

And FIG. 7 is a diagram illustrating a view observed on the display based on the user's current state and indoor illuminance without applying adaptive correction, and FIG. 8 is a diagram illustrating a view observed on a display based on the user's current state and indoor illuminance with adaptive correction applied.

First, as shown in FIG. 1, an augmented reality head-mounted display (hereinafter referred to as an “AR HMD”) according to the present disclosure can be used to provide a 360° panoramic image generated using a plurality of externally mounted cameras on a vehicle, such as a tank or armored vehicle to a user as a first-person point of view (POV) by conjunction it with the user's head pose.

An AR HMD according to the present disclosure may include a display, an electrochromic module, a user state detector, an illuminance detector, a processor, and a memory.

The display may provide a virtual object generated using a plurality of cameras installed outdoors to a user located indoors as a first-person point of view (POV).

The electrochromic module may adjust its opacity in response to control of the processor.

The user state detector may utilize the user's visual system to detect the current state of the user wearing the AR HMD.

The user state detector for detecting the current state of the user may include a front-facing camera and a binocular camera.

The front-facing camera may generate RGB images and depth images, and the binocular camera may generate left-eyeball images and right-eyeball images of the user.

The processor may categorize the current state of the user based on the results detected by the user state detector.

For example, the processor may classify the current state of a user wearing the AR HMD inside a tank, armored vehicle, etc. as one of an idle state, an outdoor environmental monitoring state, or an indoor equipment operation state.

Here, the ‘outdoor environment monitoring state’ refers to a state in which the user monitors an outdoor environment via a 360° panoramic image generated by the plurality of cameras.

And the ‘indoor equipment operation state’ refers to a state in which the user is fixing his or her gaze on the equipment in order to operate the equipment provided indoors.

And the ‘idle state’ refers to a state other than the outdoor environmental monitoring state and the indoor equipment operation state.

The AR HMD of the present disclosure aims to achieve optimal visibility in each of the above three states by adjusting the brightness of the display and the opacity of the electrochromic module depending on which state the user's current state corresponds to.

Referring to FIG. 2, when classifying the current state of the user, the processor may estimate a two-dimensional gaze point in the RGB image based on the RGB image of the front-facing camera and the pupil detection information of the binocular camera, detect a fixed gaze point from the estimated two-dimensional gaze point, and determine whether a fixed gaze point is formed.

Thereafter, when the fixed gaze point is not formed, the processor may classify the current state of the user as the idle state.

Then, when the fixed gaze point is formed, estimate a binocular convergence angle-based gaze distance utilizing a pupil line of sight information extracted from the binocular image and the estimated two-dimensional gaze point information.

And setting a depth value of a point corresponding to the estimated two-dimensional gaze point in the depth image acquired from the front-facing depth camera to the two-dimensional gaze point-based depth value.

Thereafter, when an absolute value difference between the estimated binocular convergence angle-based gaze distance and the two-dimensional gaze point-based depth value is equal to or greater than a threshold (o), the current state of the user may classify as the outdoor environment monitoring state.

And when the absolute value difference between the estimated binocular convergence angle-based gaze distance and the two-dimensional gaze point-based depth value is less than the threshold (o), the processor may classify the user's current state as an indoor equipment operation state.

An AR HMD according to the present disclosure may further comprise a user state selection button that allows a user to select a user state.

In this case, when a user's current state is selected via the user state selection button, the AR HMD may adjust the brightness of the display and the opacity of the electrochromic module based on the selected user's current state.

The user state selection button allows for semi-autonomous control of the AR HMD.

The AR HMD according to the present disclosure may further comprise a manual adjustment button for changing the preset values according to user-specific preferences and/or tastes.

In this case, the user can adjust the display brightness control value and the electrochromic module control value via the manual adjustment buttons.

According to such a configuration, in the absence of manual input via the user state selection button, the processor of an AR HMD according to the present disclosure may perform the methods described above to categorize the user state.

In other words, in the absence of manual input via the user state selection button, the processor may perform processes such as estimating a two-dimensional gaze point, detecting a fixed gaze point, determining whether a fixed gaze point is formed, estimating a binocular convergence angle-based gaze distance, setting a two-dimensional gaze point-based depth value, and calculating a difference between the binocular convergence angle-based gaze distance and the two-dimensional gaze point-based depth value.

The illuminance detector may be used to sense the illuminance of the indoors and the outdoors.

In this embodiment, indoor illuminance can be detected by an illuminance sensor installed indoors and a front-facing camera mounted on the AR HMD, and outdoor illuminance can be detected by a binocular camera mounted on the AR HMD.

For example, the processor may measure the indoor illuminance by calculating the illuminance from a signal from an illuminance sensor installed indoors and an image generated by a front-facing camera.

And the processor may measure the outdoor illuminance by calculating the illuminance of the eyeball image generated by the binocular camera, that is, the illuminance of the outdoor image reflected from the eye.

Referring to FIG. 3, the processor may perform an initialization step of setting an initial control value of the display and an initial control value of the electrochromic module according to the classified current state of the user and recording indoor illuminance information and outdoor illuminance information at that time in the memory.

Referring to FIG. 4, in the initialization step, the processor may perform an initial value setting step to set a user-customized display brightness initial control value and an electrochromic module opacity initial control value by applying a user-customized adjustment value

$$( {ℒ}_{disp}^{control} , {ℒ}_{dimm}^{control} )$$

to the preset display brightness and electrochromic module opacity adjustment value

$$( {[ {ℒ}_{disp}^{default} ]}_{s} , {[ {ℒ}_{dimm}^{default} ]}_{s} )$$

according to a classified current state of the user.

In the initial value setting step, the default values for the display brightness and opacity of the electrochromic module based on the user state may be defined as follows.

$$( {[ {ℒ}_{disp}^{default} ]}_{s} , {[ {ℒ}_{dimm}^{default} ]}_{s} ) = \{ \begin{matrix}( 0.5 , 0.5 ) & where S = IDLE \\ ( 0.8 , 0.2 ) & where S = MONITORING \\ ( 0.2 , 0.8 ) & where S = OPERATING\end{matrix}$$

Here, the larger the value of [symbol] the brighter the display brightness, and the larger the value of [symbol] , the less (more) opacity (transparency).

And in the initial value setting step, the display brightness initial control value and the electrochromic module opacity initial control value

$$( {[ {ℒ}_{disp , dimm}^{init} ]}_{s} )$$

may be defined by summing the respective predefined adjustment values

$$( {[ {ℒ}_{disp , dimm}^{default} ]}_{s} )$$

and the user-customized adjustment value

$$( {ℒ}_{disp , dimm}^{control} ) .$$

$${[ {ℒ}_{disp}^{init} ]}_{s} = \{ \begin{matrix}min ( {[ {ℒ}_{disp}^{default} ]}_{s} + {ℒ}_{disp}^{control} , {ℒ}_{disp}^{max} ) & {if [ {ℒ}_{disp}^{default} ]}_{s} + {ℒ}_{disp}^{control} > {ℒ}_{disp}^{max} \\ max ( {[ {ℒ}_{disp}^{default} ]}_{s} + {ℒ}_{disp}^{control} , {ℒ}_{disp}^{min} ) & else {if [ {ℒ}_{disp}^{default} ]}_{s} + {ℒ}_{disp}^{control} \leq {ℒ}_{disp}^{min}\end{matrix} ,$$

$${ℒ}_{disp}^{control} ∈ [ - 1. , 1. ] , {ℒ}_{disp}^{min} = 0.2 , {ℒ}_{disp}^{max} = 0.8$$

Thereafter, the step of recording environmental information may be performed to record indoor illuminance

$$( {ℬ}_{ambient}^{init} )$$

and outdoor illuminance

$$( {ℬ}_{eye}^{init} )$$

in the memory, along with the classified current state of the user.

In the step of recording environmental information, the indoor illuminance information ( [symbol] ) may be defined as a weighted sum of the normalized brightness value ( [symbol] ) of the illuminance sensor and the normalized average brightness value ( [symbol] ) of the RGB image.

$${ℬ}_{ambient} = a \cdot {ℬ}_{sensor} + b \cdot {ℬ}_{image} , a = ( 0 , 1 ) , b = 1 - a$$

And the outdoor illuminance information ( [symbol] ) may be defined as the average value of the normalized mean brightness values for the left-eyeball image and right-eyeball image, respectively.

$${ℬ}_{eye} = \frac{( {ℬ}_{eye}^{L} + {ℬ}_{eye}^{R} )}{2}$$

Referring to FIG. 5, after performing the initialization step, the processor may perform an adaptive correction step to automatically adjust the brightness of the display and the opacity of the electrochromic module to maintain the indoor illuminance and outdoor illuminance recorded in the memory.

Referring to FIG. 6, in the adaptive correction step, the processor may perform a target illuminance information acquisition step in which indoor illuminance information

$$( {[ {ℬ}_{ambient}^{init} ]}_{s} )$$

and outdoor illuminance information

$$( {[ {ℬ}_{eye}^{init} ]}_{s} )$$

corresponding to the classified current state S of the user are retrieved from memory.

Thereafter, the processor may perform the step of extracting environmental illuminance information, which may include measuring indoor illuminance ( [symbol] ) detected from the front-facing camera and the illuminance sensor and measuring outdoor illuminance ( [symbol] ) detected from the binocular camera.

Thereafter, the processor may perform a correction control step in which the target illuminance information and the measured environmental illuminance information are compared to calculate and apply a display brightness correction control value and an electrochromic module opacity correction control value

$$( ( {ℒ}_{disp}^{update} , {ℒ}_{dimm}^{update} ) ) .$$

Here, it is desirable to design the environmental illuminance information extraction step and the correction control step as a feedback structure to adaptively adjusted the display brightness and the opacity of the electrochromic module to maintain the target illuminance value even when the external environment changes.

And in the correction control step, the processor may calculate an electrochromic module opacity correction control value that minimizes the difference between the indoor illuminance set value and the indoor illuminance measured value.

$${ℒ}_{dimm}^{update} ← Minimize \vert {f}_{{ℬ}_{ambient}} ( {ℒ}_{dimm} ) - {ℬ}_{ambient}^{init} \vert , {ℒ}_{dimm}^{min} \leq {ℒ}_{dimm} \leq {ℒ}_{dimm}^{max}$$

Here, ƒ [symbol] ( [symbol] ) is the indoor illuminance measurement when the electrochromic module opacity control value is [symbol] .

And in the correction control step, the processor may calculate a display brightness control value that minimizes the difference between the outdoor illuminance set value and the outdoor illuminance measured value under the calculated electrochromic module opacity condition.

$${ℒ}_{disp}^{update} ← Minimize \vert {f}_{{ℬ}_{eye}} ( {ℒ}_{disp} ) - {ℬ}_{eye}^{init} \vert , {ℒ}_{disp}^{min} \leq {ℒ}_{disp} \leq {ℒ}_{disp}^{max}$$

Here, ƒ [symbol] ( [symbol] ) is a measure of indoor illuminance (eye image brightness) when the display brightness control value is [symbol] .

And in the correction control step, the processor may calculate a correction control value to reduce the brightness of the display and the opacity of the electrochromic module when the real world is closer than a certain distance, by referring to a minimum distance value of the depth image.

$${ℒ}_{dimm}^{update} ← max ( 0 , 1 - {𝒟}_{min} / {𝒟}_{thresh} ) + ( 1 - max ( 0 , 1 - {𝒟}_{min} / {𝒟}_{max} ) ) \cdot {ℒ}_{dimm}^{update} , 0 < {𝒟}_{thresh} \leq 1$$

$${ℒ}_{disp}^{update} ← max ( 0 , 1 - {𝒟}_{min} / {𝒟}_{thresh} ) + ( 1 - max ( 0 , 1 - {𝒟}_{min} / {𝒟}_{max} ) ) \cdot {ℒ}_{disp}^{update} , 0 < {𝒟}_{thresh} \leq 1$$

Here, [symbol] is a minimum distance value in the depth image normalized to the range 0 to 1, and [symbol] is a threshold distance value between the real world and the user to reduce the display brightness and electrochromic module opacity.

FIG. 7 is a diagram illustrating a view observed on the display based on the user's current state and indoor illuminance without applying adaptive correction, and FIG. 8 is a diagram illustrating a view observed on a display based on the user's current state and indoor illuminance with adaptive correction applied.

Referring to FIG. 7, when adaptive correction is not applied, the display brightness control value set in the low light environment and the opacity control value of the electrochromic module are fixed, so that when the outdoor illuminance increases, the augmented image (virtual object) and the real world are not correctly visible in each state.

That is, as shown in FIG. 7, in the idle state, optimal viewing is possible in medium light conditions, in the outdoor environmental monitoring state, optimal viewing is possible in low light conditions, and in the indoor equipment operation state, optimal viewing is possible in high light conditions.

However, referring to FIG. 8, when adaptive correction is applied, the display brightness adjustment value set in a low-light environment and the opacity adjustment value of the electrochromic module are automatically updated in response to changes in outdoor illuminance, allowing for optimal viewing regardless of the driver's state (idle state, outdoor environment monitoring state, indoor equipment operation state) and indoor illuminance (low, medium, high).

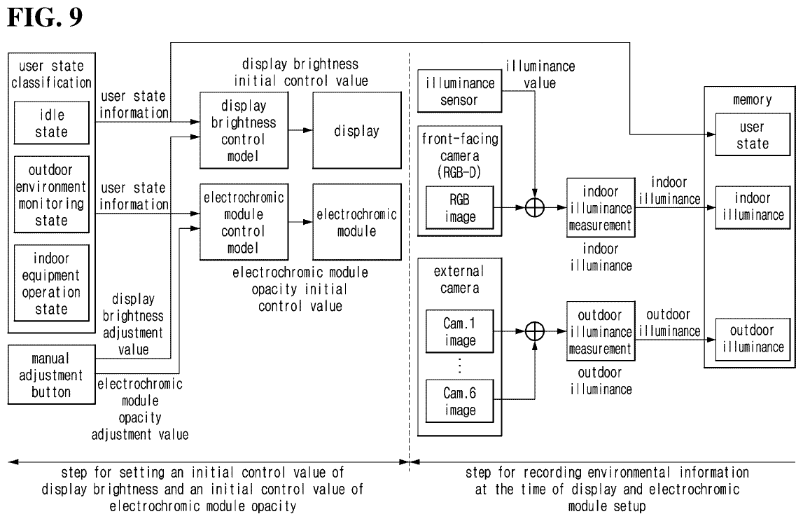

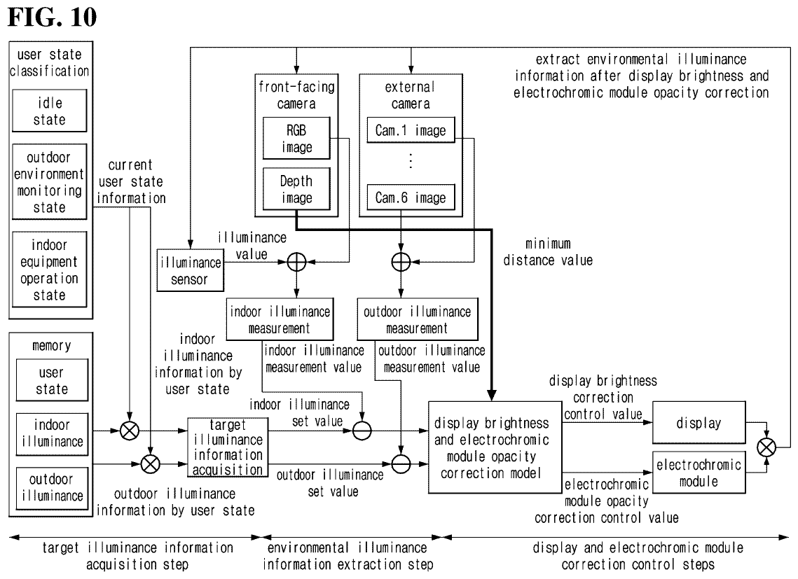

FIG. 9 is a diagram specifically illustrating another example of the initialization step illustrated in FIG. 3, and FIG. 10 is a diagram specifically illustrating another example of the adaptive correction step illustrated in FIG. 3.

The AR HMD of this embodiment differs from the AR HMD of the preceding embodiments in the method of measuring outdoor illuminance, while the remaining configuration may be the same as the AR HMD of the preceding embodiments.

Accordingly, in describing the present embodiments, the same components as in the preceding embodiments will be omitted from detailed description.

In the AR HMD of the above embodiment, outdoor illuminance was measured using outdoor images reflected from the user's eyeballs taken using a binocular camera.

However, in the AR HMD of this embodiment, the outdoor illuminance is measured from images of the plurality of cameras installed on the exterior of the tank or armored vehicle to generate a 360° panoramic image.

Further, in the initialization step and the adaptive correction step performed by the processor, the outdoor illuminance information measured from the images of the plurality of cameras may be used instead of the outdoor illuminance information measured from the eyeball image.

It is apparent to those skilled in the art that the present disclosure can be embodied in other specific forms without departing from essential features of the present disclosure. Accordingly, the above detailed description should not be construed as limiting in all aspects and should be considered as illustrative. The scope of the present disclosure should be determined by rational construing of the appended claims, and all modifications within an equivalent scope of the present disclosure are included in the scope of the present disclosure.

What is claimed is:

1. An augmented reality head-mounted display comprising an electrochromic module, comprising:
a display for presenting virtual objects generated using a plurality of cameras mounted outdoors to a user located indoors in a first-person point of view (POV);
an electrochromic module for adjusting an opacity of the display;
a user state detector for detecting a current state of the user utilizing a visual mechanism of the user;
an illuminance detector for detecting an illuminance level of the indoors and the outdoors; and
a processor for adjusting a brightness of the display and an opacity of the electrochromic module in response to the user's current state detected by the user state detector and the illuminance level detected by the illuminance detector.

2. The augmented reality head-mounted display comprising an electrochromic module of claim 1,
wherein the user state detector comprises a front-facing camera that generates an RGB image and a depth image, and a binocular camera that generates a left-eyeball image and a right-eyeball image of the user.

3. The augmented reality head-mounted display comprising an electrochromic module of claim 2,
wherein the processor classifies a current state of the user based on the results detected by the user state detector, and the current state of the user as one of an idle state, an outdoor environment monitoring state, and an indoor equipment operation state.

4. The augmented reality head-mounted display comprising an electrochromic module of claim 3,
when classifying the current state of the user, the processor,
estimate a two-dimensional gaze point in the RGB image based on the RGB image of the front-facing camera and the pupil detection information of the binocular camera, detect a fixed gaze point from the estimated two-dimensional gaze point, and determine whether the fixed gaze point is formed,
when the fixed gaze point is not formed, classify the current state of the user as the idle state,
when the fixed gaze point is formed, estimate a binocular convergence angle-based gaze distance utilizing a pupil line of sight information extracted from the binocular image and the estimated two-dimensional gaze point information, and set a depth value of a point corresponding to the estimated two-dimensional gaze point in the depth image acquired from the front-facing camera to the two-dimensional gaze point-based depth value,
when an absolute value difference between the estimated binocular convergence angle-based gaze distance and the two-dimensional gaze point-based depth value is equal to or greater than a threshold, classify the current state of the user as the outdoor environment monitoring state, and
when the absolute value difference between the estimated binocular convergence angle-based gaze distance and the two-dimensional gaze point-based depth value is less than the threshold, classify the current state of the user as the indoor equipment operation state.

5. The augmented reality head-mounted display comprising an electrochromic module of claim 3,
wherein the illuminance detector includes an illuminance sensor to detect indoor illuminance, and
wherein the processor measures indoor illuminance using an image generated by the front-facing camera and a signal from the illuminance sensor and outdoor illuminance using an eyeball image generated by the binocular camera or an outdoor image generated by the plurality of cameras.

6. The augmented reality head-mounted display comprising an electrochromic module of claim 5,
wherein the processor performs an initialization step of setting an initial control value of the display and an initial control value of the electrochromic module according to the classified current state of the user and recording indoor illuminance information and outdoor illuminance information at that time in the memory, and an adaptive correction step of automatically adjusting the brightness of the display and the opacity of the electrochromic module so that the indoor illuminance and outdoor illuminance recorded in the memory are maintained.

7. The augmented reality head-mounted display comprising an electrochromic module of claim 6,
wherein in the initialization step, the processor performs an initial value setting step of setting a display brightness initial control value and an electrochromic module opacity initial control value for each user by applying a user-customized adjustment values to the preset display brightness and electrochromic module opacity adjustment values according to the classified current state of the user, and an environmental information recording step of recording indoor illuminance and outdoor illuminance in the memory along with the classified current state of the user.

8. The augmented reality head-mounted display comprising an electrochromic module of claim 6,
wherein in the adaptive correction step, the processor performs a target illuminance information acquisition step of retrieving indoor illuminance information and outdoor illuminance information corresponding to a classified current state of the user from memory, an environmental illuminance information extraction step of measuring an indoor illuminance detected from the front-facing camera and the illuminance sensor and an outdoor illuminance detected from an image of the binocular camera or an image of the plurality of cameras, and a correction control step of comparing the target illuminance information and measured environmental illuminance information to calculate and apply a display brightness correction control value and an electrochromic module opacity correction control value.

9. The augmented reality head-mounted display comprising an electrochromic module of claim 8,
wherein in the correction control step, the processor calculates an electrochromic module opacity correction control value that minimizes the difference between the indoor illuminance set value and the indoor illuminance measured value, a display brightness control value that minimizes the difference between the outdoor illuminance set value and the outdoor illuminance measured value under the calculated electrochromic module opacity condition, and the correction control value to reduce the brightness of the display and the opacity of the electrochromic module when the real world is closer than a certain distance by referring to a minimum distance value of the depth image.

10. The augmented reality head-mounted display comprising an electrochromic module of claim 4,
wherein the illuminance detector includes an illuminance sensor to detect indoor illuminance, and
wherein the processor measures indoor illuminance using an image generated by the front-facing camera and a signal from the illuminance sensor and outdoor illuminance using an eyeball image generated by the binocular camera or an outdoor image generated by the plurality of cameras.

11. The augmented reality head-mounted display comprising an electrochromic module of claim 10,
wherein the processor performs an initialization step of setting an initial control value of the display and an initial control value of the electrochromic module according to the classified current state of the user and recording indoor illuminance information and outdoor illuminance information at that time in the memory, and an adaptive correction step of automatically adjusting the brightness of the display and the opacity of the electrochromic module so that the indoor illuminance and outdoor illuminance recorded in the memory are maintained.

12. The augmented reality head-mounted display comprising an electrochromic module of claim 11,
wherein in the initialization step, the processor performs an initial value setting step of setting a display brightness initial control value and an electrochromic module opacity initial control value for each user by applying a user-customized adjustment values to the preset display brightness and electrochromic module opacity adjustment values according to the classified current state of the user, and an environmental information recording step of recording indoor illuminance and outdoor illuminance in the memory along with the classified current state of the user.

13. The augmented reality head-mounted display comprising an electrochromic module of claim 11,
wherein in the adaptive correction step, the processor performs a target illuminance information acquisition step of retrieving indoor illuminance information and outdoor illuminance information corresponding to a current state of the classified user from memory, an environmental illuminance information extraction step of measuring an indoor illuminance detected from the front-facing camera and the illuminance sensor and an outdoor illuminance detected from an image of the binocular camera or an image of the plurality of cameras, and a correction control step of comparing the target illuminance information and measured environmental illuminance information to calculate and apply a display brightness correction control value and an electrochromic module opacity correction control value.

14. The augmented reality head-mounted display comprising an electrochromic module of claim 13,
wherein in the correction control step, the processor calculates an electrochromic module opacity correction control value that minimizes the difference between the indoor illuminance set value and the indoor illuminance measured value, a display brightness control value that minimizes the difference between the outdoor illuminance set value and the outdoor illuminance measured value under the calculated electrochromic module opacity condition, and the correction control value to reduce the brightness of the display and the opacity of the electrochromic module when the real world is closer than a certain distance by referring to a minimum distance value of the depth image.
